(19) United States
(12) Patent Application Publication
(10) Pub. No.: US 2019/0150654 A1
(43) Pub. Date: May 23, 2019

(54) Coffee Maker Assembly

(71) Applicant: Ray Milhem, McMurray, PA (US)

(72) Inventor: Ray Milhem, McMurray, PA (US)

(21) Appl. No.: 15/816,427

(22) Filed: Nov. 17, 2017

(51) Int. Cl. A47J 31/06; A47J 31/44

(52) U.S. Cl. CPC A47J 31/06; A47J 31/4403

(57) ABSTRACT

A coffee maker assembly includes a coffee maker for brewing a pot of coffee and the coffee maker has a filter basket. A sensor is coupled to the filter basket to detect when a filter is positioned in the filter basket. A communication unit is coupled to the coffee maker and the communication unit is electrically coupled to the sensor. The sensor communicates when a filter is positioned in the filter basket for brewing the pot of coffee. Additionally, the communication unit tracks a time of day to communicate to a user when the pot of coffee was brewed. The communication unit is in electrical communication with an extrinsic electronic device thereby facilitating the extrinsic electronic device to display when the pot of coffee was brewed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to coffee devices and more particularly pertains to a new coffee device for displaying when a pot of coffee was brewed.

### BRIEF SUMMARY OF THE INVENTION

An embodiment of the disclosure meets the needs presented above by generally comprising a coffee maker for brewing a pot of coffee and the coffee maker has a filter basket. A sensor is coupled to the filter basket to detect when a filter is positioned in the filter basket. A communication unit is coupled to the coffee maker and the communication unit is electrically coupled to the sensor. The sensor communicates when a filter is positioned in the filter basket for brewing the pot of coffee. Additionally, the communication unit tracks a time of day to communicate to a user when the pot of coffee was brewed. The communication unit is in electrical communication with an extrinsic electronic device thereby facilitating the extrinsic electronic device to display when the pot of coffee was brewed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a coffee maker assembly according to an embodiment of the disclosure.

FIG. 2 is a front phantom view of an embodiment of the disclosure.

FIG. 3 is a schematic view of an embodiment of the disclosure.

### DETAILED DESCRIPTION OF THE INVENTION

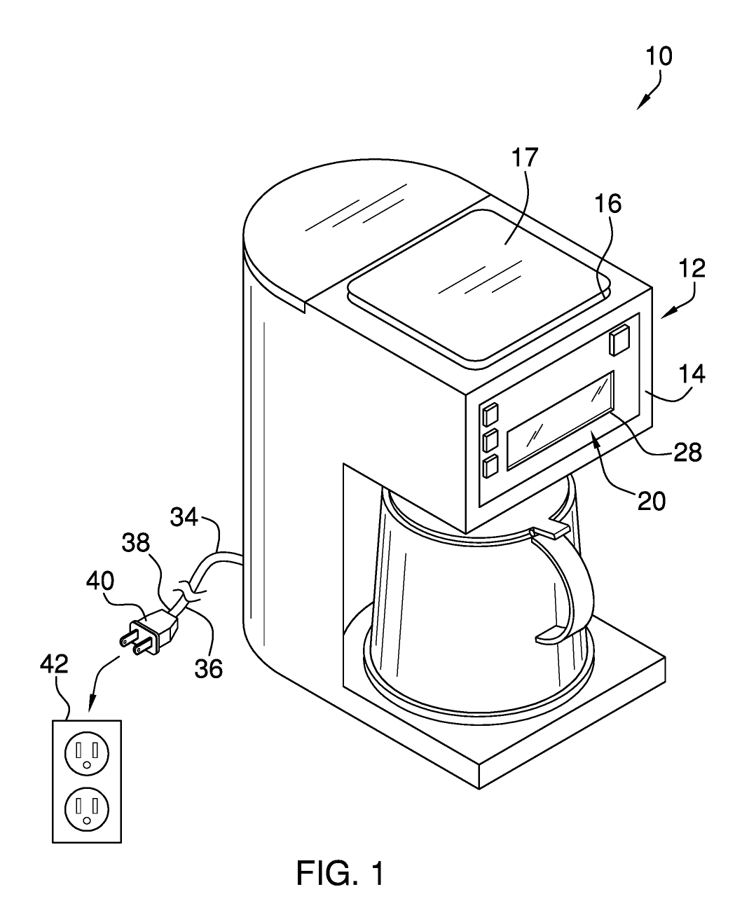

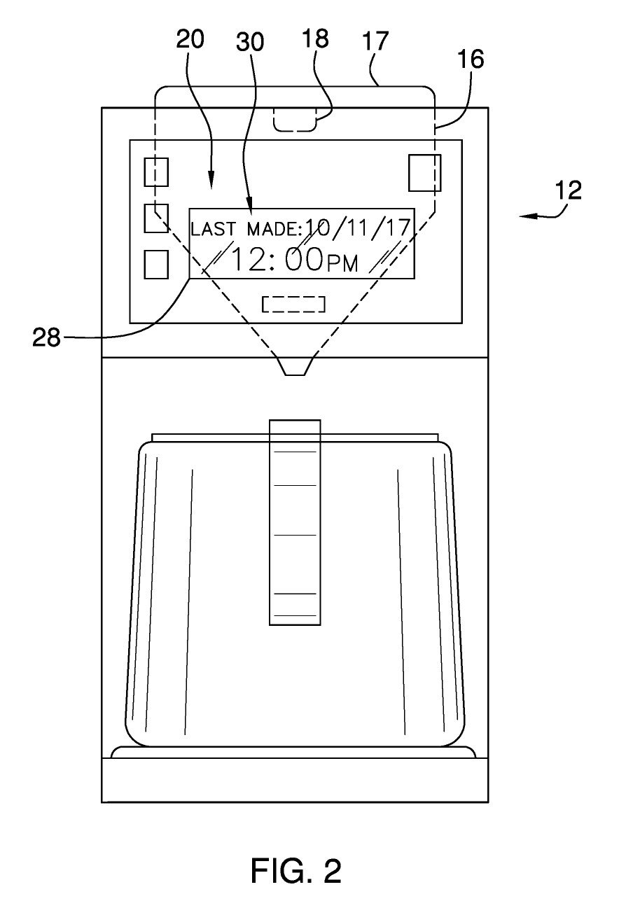

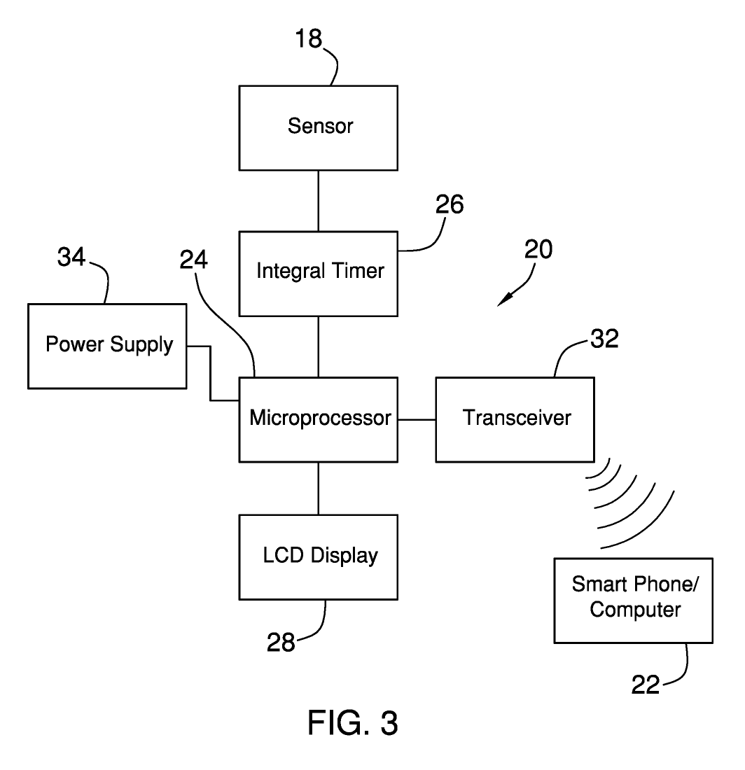

With reference now to the drawings, and in particular to FIGS. 1 through 3 thereof, a new coffee device embodying the principles and concepts of an embodiment of the disclosure and generally designated by the reference numeral 10 will be described.

As best illustrated in FIGS. 1 through 3, the coffee maker assembly 10 generally comprises a coffee maker 12 for brewing a pot of coffee. The coffee maker 12 has a front side 14 and a filter basket 16. The coffee maker 12 may have a lid 17 that is hingedly positioned over the filter basket 16 for selectively opening and closing the filter basket 16. The coffee maker 12 may be an electronic coffee maker of any conventional design and the coffee maker may include controls common to electronic coffee makers.

A sensor 18 is coupled to the filter basket 16 to detect when a coffee filter is positioned in the filter basket 16. The sensor 18 may comprise a switch that is in communication with the lid 17 such that the sensor 18 detects when the lid 17 is opened. Additionally, the sensor 18 may be a light sensor that detects light when the lid 17 is opened. The sensor 18 may comprise a switch that senses when the filter basket 16 is removed from the coffee maker 12. In summary, the sensor 18 comprises any electronic sensor that is capable of detecting when the coffee filter is positioned in the filter basket 16.

A communication unit 20 is provided and the communication unit 20 is coupled to the coffee maker 12. The communication unit 20 is electrically coupled to the sensor 18. Thus, the sensor 18 communicates to the communication unit 20 when a filter is positioned in the filter basket 16 for brewing the pot of coffee. The communication unit 20 tracks a time of day to communicate to a user when the pot of coffee was brewed. In this way the user is able to determine whether coffee in the coffee pot is fresh before pouring a cup of coffee. Moreover, the communication unit 20 is in electrical communication with an extrinsic electronic device 22 thereby facilitating the extrinsic electronic device 22 to display when the pot of coffee was brewed. The extrinsic electronic device 22 may be a smart phone, a laptop computer and any other electronic device that is capable of wireless communication.

The communication unit 20 comprises a processor 24 that is positioned in the coffee maker 12 and the processor 24 is electrically coupled to the sensor 18. The processor 24 generates a time stamp sequence when the sensor 18 detects the filter has been positioned in the filter basket 16. The processor 24 may comprise an electronic processor 24 or the like. An electronic timer 26 is positioned in the coffee maker 12 and the electronic timer 26 is electrically coupled to the processor 24. The electronic timer 26 tracks a time of day and a calendar date. Moreover, the electronic timer 26 communicates to the processor 24 a time of day when the processor 24 generates the time stamp sequence.

A display 28 is coupled to the front side 14 of the coffee maker 12 such that the display 28 is visible to a user. The display 28 is electrically coupled to the processor 24 and the display 28 displays indicia 30. The indicia 30 comprise numbers corresponding to the time of day and the calendar date when the processor 24 generates the time stamp sequence. In this way the display 28 communicates to the user when the pot of coffee was brewed. The display 28 may comprise an LCD or the like.

A transceiver 32 is positioned in the coffee maker 12 and the transceiver 32 is electrically coupled to the processor 24. The transceiver 32 is in wireless electrical communication with the extrinsic electronic device 22 thereby facilitating the extrinsic electronic device 22 to display the time of day the pot of coffee was brewed. The transceiver 32 may be a radio frequency transceiver 32 and the transceiver 32 may employ a WPAN signal and Bluetooth communication protocols.

A power supply 34 is provided and the power supply 34 is coupled to the coffee maker 12 and the power supply 34 is electrically coupled to the processor 24. The power supply 34 comprises a power cord 36 extending outwardly from the coffee maker 12. The power cord 36 has a distal end 38 with respect to the coffee maker 12 and a plug 40 is electrically coupled to the distal end 38. The plug 40 electrically coupled to a power source 42 and the power source 42 may be a female electrical outlet or the like.

In use, a coffee filter is positioned in the filter basket 16 for brewing a pot of coffee. The sensor 18 senses when the filter is positioned in the filter basket 16 and the processor 24 generates the time stamp sequence. The electronic timer 26 communicates the time of day and the calendar date to the processor 24 when the processor 24 generates the time stamp sequence. Thus, the display 28 displays the time of day and the calendar date thereby facilitating the user to identify an age of the pot of coffee. Additionally, the transceiver 32 transmits the time of day and the calendar date to the extrinsic electronic device 22 so the user can remotely identify the age of the pot of coffee.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A coffee maker assembly being configured to be in wireless communication with an extrinsic electronic device for communicating when coffee has been brewed, said assembly comprising:
a coffee maker being configured to brew a pot of coffee, said coffee maker having a front side and a filter basket;
a sensor being coupled to said filter basket wherein said sensor is configured to detect when a filter is positioned in said filter basket;
a communication unit being coupled to said coffee maker, said communication unit being electrically coupled to said sensor wherein said sensor communicates when a filter is positioned in said filter basket for brewing the pot of coffee, said communication unit tracking a time of day wherein said communication unit is configured to communicate to a user when the pot of coffee was brewed, said communication unit being in electrical communication with an extrinsic electronic device thereby facilitating the extrinsic electronic device to display when the pot of coffee was brewed.

2. The assembly according to claim 1, wherein said communication unit comprises a processor being positioned in said coffee maker, said processor being electrically coupled to said sensor, said processor generating a time stamp sequence when said sensor detects the filter has been positioned in said filter basket.

3. The assembly according to claim 2, further comprising an electronic timer being positioned in said coffee maker, said electronic timer being electrically coupled to said processor, said electronic timer tracking a time of day, electronic timer communicating to said processor a time of day when said processor generates said time stamp sequence.

4. The assembly according to claim 3, further comprising a display being coupled to said front side of said coffee maker wherein said display is configured to be visible to a user, said display being electrically coupled to said processor, said display displaying indicia, said indicia comprising numbers corresponding to the time of day when said processor generates said time stamp sequence wherein said display is configured to communicate to the user when the pot of coffee was brewed.

5. The assembly according to claim 2, further comprising a transceiver being positioned in said coffee maker, said transceiver being electrically coupled to said processor, said transceiver being configured to be in electrical communication with the extrinsic electronic device thereby facilitating the extrinsic electronic device to display the time of day the pot of coffee was brewed.

6. The assembly according to claim 2, further comprising a power supply being coupled to said coffee maker, said power supply being electrically coupled to said processor, said power supply comprising a power cord extending outwardly from said coffee maker, said power cord having a distal end with respect to said coffee maker, said distal end having a plug being electrically coupled thereto, said plug being configured to be electrically coupled to a power source.

7. A coffee maker assembly being configured to be in wireless communication with an extrinsic electronic device for communicating when coffee has been brewed, said assembly comprising:
a coffee maker being configured to brew a pot of coffee, said coffee maker having a front side and a filter basket;
a sensor being coupled to said filter basket wherein said sensor is configured to detect when a filter is positioned in said filter basket;
a communication unit being coupled to said coffee maker, said communication unit being electrically coupled to said sensor wherein said sensor communicates when a filter is positioned in said filter basket for brewing the pot of coffee, said communication unit tracking a time of day wherein said communication unit is configured to communicate to a user when the pot of coffee was brewed, said communication unit being in electrical communication with an extrinsic electronic device thereby facilitating the extrinsic electronic device to display when the pot of coffee was brewed, said communication unit comprising:
a processor being positioned in said coffee maker, said processor being electrically coupled to said sensor, said processor generating a time stamp sequence when said sensor detects the filter has been positioned in said filter basket;
an electronic timer being positioned in said coffee maker, said electronic timer being electrically coupled to said processor, said electronic timer tracking a time of day, electronic timer communicating to said processor a time of day when said processor generates said time stamp sequence;
a display being coupled to said front side of said coffee maker wherein said display is configured to be visible to a user, said display being electrically coupled to said processor, said display displaying indicia, said indicia comprising numbers corresponding to the time of day when said processor generates said time stamp sequence wherein said display is configured to communicate to the user when the pot of coffee was brewed;
a transceiver being positioned in said coffee maker, said transceiver being electrically coupled to said processor, said transceiver being configured to be in electrical communication with the extrinsic electronic device thereby facilitating the extrinsic electronic device to display the time of day the pot of coffee was brewed; and
a power supply being coupled to said coffee maker, said power supply being electrically coupled to said processor, said power supply comprising a power cord extending outwardly from said coffee maker, said power cord having a distal end with respect to said coffee maker, said distal end having a plug being electrically coupled thereto, said plug being configured to be electrically coupled to a power source.
